(19) United States
(12) Patent Application Publication
(10) Pub. No.: US 2008/0235956 A1
(43) Pub. Date: Oct. 2, 2008

(54) HINGED CUTTING TOOL CONFIGURED FOR SEVERING ELONGATED FOLIAGE PROTRUDING THROUGH AN OPENING IN A SCREEN

(76) Inventors: Fredrick T. Molis, Jacksonville, FL (US); Gary A. Metz, Jacksonville, FL (US)

Correspondence Address: MARK YOUNG, P.A., 12086 FORT CAROLINE ROAD, UNIT 202, JACKSONVILLE, FL, 32225, US

(21) Appl. No.: 11/692,898

(22) Filed: Mar. 28, 2007

(51) Int. Cl. B26B 7/00

(52) U.S. Cl. 30/272.1

(57) ABSTRACT

A hinged foliage cutter adapted for use against a surface of a screen enclosure includes a cutting head with a substantially flat top side to maintain contact with the screen during use. A handle is hingedly attached to a distal end of the cutting head. A cutting blade and comb assembly are attached to a proximal end of the cutting head. The comb assembly includes a plurality of comb teeth abutting the cutting blade and extending beyond the tip of the cutting blade by a determined length. The distal end of the handle is configured for releasable attachment to an extension pole to facilitate reaching the interior side of a screen roof of a screen enclosure. As the cutting head is moved along the surface of the screen, protruding foliage within the path of movement is directed by the comb into the cutting blade, which severs the foliage.

### FIELD OF THE INVENTION

This invention relates generally to tools for cleaning screen enclosures, and, more particularly, to a hinged cutter adapted for use from the inside of a screen enclosure and configured to cut portions of elongated foliage, such as pine needles, stems and the like, that protrude through openings in the screen enclosure, thereby making the severed foliage easy to remove with a stream of air or water.

### BACKGROUND

Screen enclosures surround many home swimming pools, patios and lanais. Typically, screen enclosures are comprised of a plurality of screen walls and a screen roof. The enclosures provide many practical advantages, such as security, bug and pest protection, a significant reduction in leaf and airborne debris contamination of pool water, a corresponding decrease in chemical and maintenance costs, and enhanced privacy.

Unfortunately, over time, debris, such as leaves, twigs, stems, and pine needles, will accumulate on screen roofs, particularly those roofs that are adjacent to trees. Accumulated debris is unsightly, may damage screens and impedes sunlight. The weight of wet debris can cause a screen to sag or tear. Additionally, accumulated debris attracts insects and is conducive to harmful mold and mildew.

Periodically, a screen enclosure must be cleaned. Typically, a person within the enclosure will spray a stream of water form a hose or pressure washer, or direct a stream of air from a leaf blower, at the underside of the debris, propelling it off the roof. While such techniques work well for leaves and other broad surface debris, they are ineffective for removing pine needles, cypress needles, stems, twigs, and other unsightly debris with portions extending through openings in the screen. Other approaches entail sweeping, raking or scraping debris from the outside of the screen enclosure while standing on a ladder. Not only are these approaches dangerous due to the fact that laborious work must be conducted on a ladder, but they are extremely time consuming as the ladder must be repositioned to reach areas of the screen roof. Additionally, these approaches tend to break brittle needles, stems and twigs, leaving portions lodged in screen openings.

A more effective, efficient and safer tool and methodology for removing pine needles, cypress needles, stems, twigs and other thin elongated debris from screens is needed. The invention is directed to fulfilling one or more of the needs and overcoming one or more of the problems as set forth above.

### SUMMARY OF THE INVENTION

To overcome one or more of the problems as set forth above, in one aspect of the invention, a hinged foliage cutter adapted for use against a surface of a screen enclosure is provided. The hinged foliage cutter includes a cutting head with a proximal end, a distal end, a top side and a bottom side. The top side of the cutting head is substantially flat. A handle is hingedly attached to the distal end of the cutting head. A cutting blade is attached to the proximal end of the cutting head. The cutting blade has a top side, a bottom side and a tip. A comb assembly is attached to the proximal end of the cutting head. The comb assembly includes a plurality of comb teeth abutting the cutting blade and extending beyond the tip of the cutting blade by a determined length. The distal end of the handle may include means for releasable attachment to an extension pole such as spring biased button snap attachments; apertures for receiving spring biased button snap attachments; female threads; male threads; or a tapered interior compartment.

In another aspect of the invention, the cutting head includes a blade housing adapted for releasably receiving a cutting blade and a comb assembly. The comb assembly includes means for releasable attachment to the cutting head. The comb assembly further includes a top comb layer, a bottom comb layer and a comb tip adjoining the top comb layer to the bottom comb layer, such that the comb assembly has a u-shaped profile. The cutting blade includes a blade with a sharp tip at one end and a base at the opposite end. The cutting blade is inserted into the comb assembly up to the base. The comb assembly provides a plurality of comb teeth separated by a determined distance, such as 1/16 to ¼ inches. The plurality of comb teeth extend beyond the tip of the cutting blade by a determined length, such as ⅛ to ½ inches.

In yet another aspect of the invention, the hinged foliage cutter includes a biasing mechanism such as a torsion spring adapted to urge the cutting head to a determined angular position relative to the handle. The determined angular position relative to the handle may be zero degrees. The biasing mechanism urges the cutting head to the determined angular position by producing a torque sufficient to overcome gravitational force acting on the cutting head, but not so great as to damage a screen.

In yet another aspect of the invention, the hinged foliage cutter includes an integral combed cutting blade having a plurality of cutting surfaces separated by comb teeth. The integral combed blade may be releasably attached to the blade housing.

### BRIEF DESCRIPTION OF THE DRAWINGS

The foregoing and other aspects, objects, features and advantages of the invention will become better understood with reference to the following description, appended claims, and accompanying drawings, where:

FIG. 1A is a side plan view of an exemplary hinged cutting tool according to principles of the invention conceptually shown in use cutting a pine needle extending through an opening of a screen;

FIG. 1B is a side view of a proximal end of an exemplary extension pole with button snap attachments according to principles of the invention;

FIG. 1C is a side view of a proximal end of an exemplary extension pole with a threaded end according to principles of the invention;

FIG. 2A is a top plan view of an exemplary hinged cutting tool according to principles of the invention;

FIG. 2B is a top magnified view of a portion of a cutting blade and comb assembly of an exemplary hinged cutting tool according to principles of the invention;

FIG. 3A is a top plan view of a blade housing of an exemplary hinged cutting tool according to principles of the invention;

FIG. 3B is an exploded view of a cutting blade and comb assembly of an exemplary hinged cutting tool according to principles of the invention;

FIG. 3C is a top plan view of a blade assembly comprised of an assembled cutting blade and comb assembly of an exemplary hinged cutting tool according to principles of the invention;

FIG. 3D is a side exploded cross-sectional view of a cutting blade and comb assembly of an exemplary hinged cutting tool according to principles of the invention;

FIG. 4 is a top perspective view of an exemplary hinged cutting tool according to principles of the invention;

FIG. 5 is a perspective view of a woman using an exemplary hinged cutting tool according to principles of the invention;

FIG. 6A is an exploded view of another exemplary cutting head, including a top view of blade housing and a bottom view of an integral combed cutting blade of an exemplary hinged cutting tool according to principles of the invention; and

FIG. 6B is a profile view of another assembled exemplary cutting head, including a blade housing and an attached integral combed cutting blade of an exemplary hinged cutting tool according to principles of the invention; and

FIG. 7 is a profile view of an assembled exemplary cutting head, including an extended blade housing and an attached integral combed cutting blade of an exemplary hinged cutting tool according to principles of the invention; and

FIG. 8 is a top plan view of an assembled exemplary cutting head, including a reciprocating cutting blade assembly according to principles of the invention; and

FIG. 9 is an exploded view of components of an exemplary pivotal cutting blade assembly according to principles of the invention.

Those skilled in the art will appreciate that the invention is not limited to the exemplary embodiments depicted in the figures or the shapes, relative sizes, proportions or materials shown in the figures.

### DETAILED DESCRIPTION

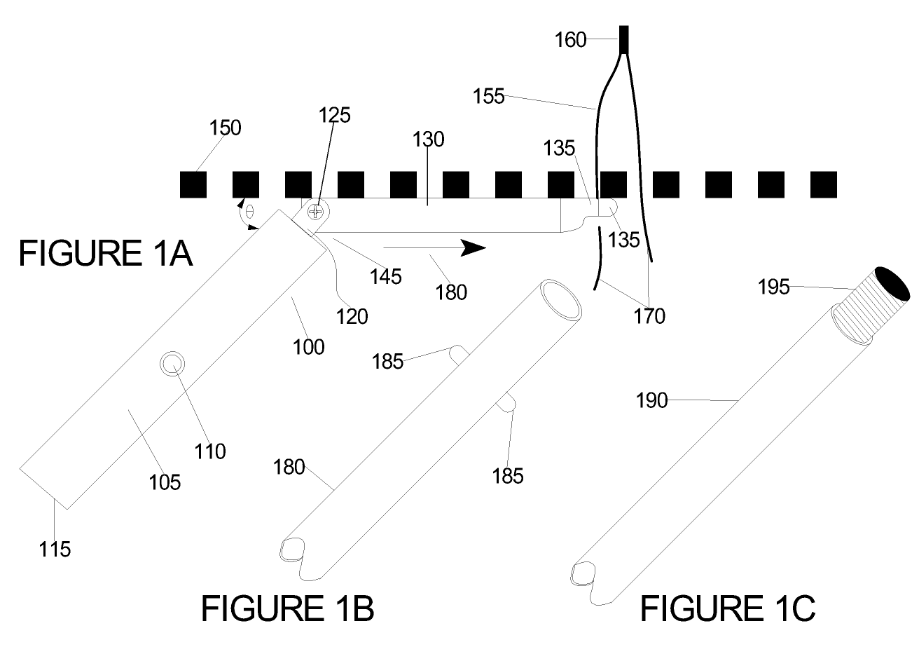

With reference to the drawings, wherein like numerals represent like features, an exemplary hinged cutting tool and components thereof according to principles of the invention are conceptually shown. In particular, FIG. 1A provides a side plan view of an exemplary hinged cutting tool 100 according to principles of the invention. The tool 100 is conceptually shown in use, cutting through a protruding pine needle 170 at the interior surface of a screen 150. The exemplary pine needle 170 is part of a pine needle bundle 155, which includes a plurality of needles 170 adjoined by a basal sheath 160. The pine needles 170 extend through a plurality of holes 165 defined in the screen 150.

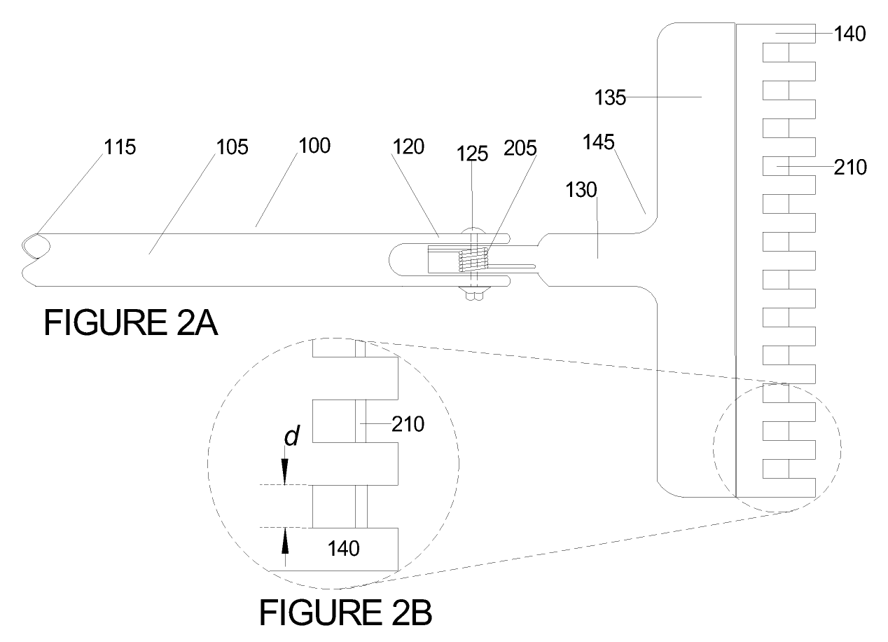

A cutting head 145 of an exemplary hinged cutting tool 100 according to principles of the invention includes a neck 130 having a hinged joint at one end and being adjoined to a blade housing 135 at the opposite end. The cutting head 145 assembly 135 includes a removable comb assembly 140 and a cutting blade 210, as shown in FIG. 2. A generally flat (i.e., planar) top surface of the cutting head enables movement of the cutting head flush against a screen surface. As the cutting head 145 is moved parallel to 180 and along the interior surface of the screen 150, the comb assembly 140 directs pine needles 170 into the cutting blade 210, which severs the pine needles 170.

A handle 105 is hingedly connected to the neck 130 of the blade housing 135. The exemplary handle 105 is generally comprised of a tubular shaft. The proximal end of the handle 105 includes a fork 120 for hinged engagement of the neck 130 of the blade housing 135. A pivot pin 125 passes through the fork 120 and the neck 130 of the blade housing 135 to enable pivotal movement of the blade housing 135 relative to the handle 105.

The handle 105 of an exemplary hinged cutting tool 100 according to principles of the invention is adapted for attachment to an extension pole, such as a pool pole. Illustratively, the distal end 115 of the handle 105 is adapted to receive the proximal end of an extension pole. By way of example and not limitation, the distal end 115 may be threaded to engage a correspondingly threaded end 195 of a pole 190, as shown in FIG. 1C. As another example, in addition to or in lieu of a threaded end, the distal end 115 of the handle 105 may include a pair of apertures 110 for receiving button snap attachments 185 on the corresponding end of a pole 180, as shown in FIG. 1B. Alternatively, for example, the distal end 115 of the handle 105 may include a pair of button snap attachments for engaging apertures in the corresponding end of a pole. The invention is not limited to any particular means for attachment, nor is the invention limited to an embodiment with a detachable pole. The pole may be removable or permanently attached or an integral part of the handle. A hinged cutting tool according to principles of the invention may also be used without an extension pole.

Referring now to FIG. 2A, a top plan view of an exemplary hinged cutting tool according to principles of the invention is provided. The cutting head 145 of the exemplary hinged cutting tool 100 according to principles of the invention includes a neck 130 that is hingedly joined to a handle 105 at one end and adjoined to a blade housing 135 at the opposite end. The blade housing 135 includes a removable comb assembly 140 and a cutting blade 210, as also shown in the magnified view of FIG. 2B. The comb assembly 140 directs elongated foliage into the cutting blade 210, which severs the foliage.

A handle 105 is hingedly connected to the neck 130 of the blade housing 135. The exemplary handle 105 is generally comprised of a tubular shaft. The proximal end of the handle 105 includes a fork 120 for hinged engagement of the neck 130 of the blade housing 135. A pivot pin 125 passes through the fork 120 and the neck 130 of the blade housing 135 to enable pivotal movement of the blade housing 135 relative to the handle 105.

In the exemplary implementation illustrated in FIG. 2A, a biasing mechanism 205 such as a torsion spring is provided to urge the cutting head 145 to a determined angular position relative to the handle 105. By way of example and not limitation, the determined angular position may be zero degrees (i.e., the cutting head 145 being in line with the handle 105). As the cutting head 145 is positioned parallel to 180 and against the interior surface of a screen 150 with the cutting head 145 at a non-zero angle relative to the handle 105, such as angle θ as shown in FIG. 1A, the biasing mechanism urges the cutting head 145 towards the determined angular position and against the screen 150. The torque produced by the biasing mechanism 205 should be sufficient to overcome gravitational force acting on the cutting head 145, but not so great as to damage a screen 150. Thus, the biasing mechanism 205 helps maintain good positioning of the cutting head 145 for cutting elongated foliage protruding through a screen 150, without damaging the screen 150.

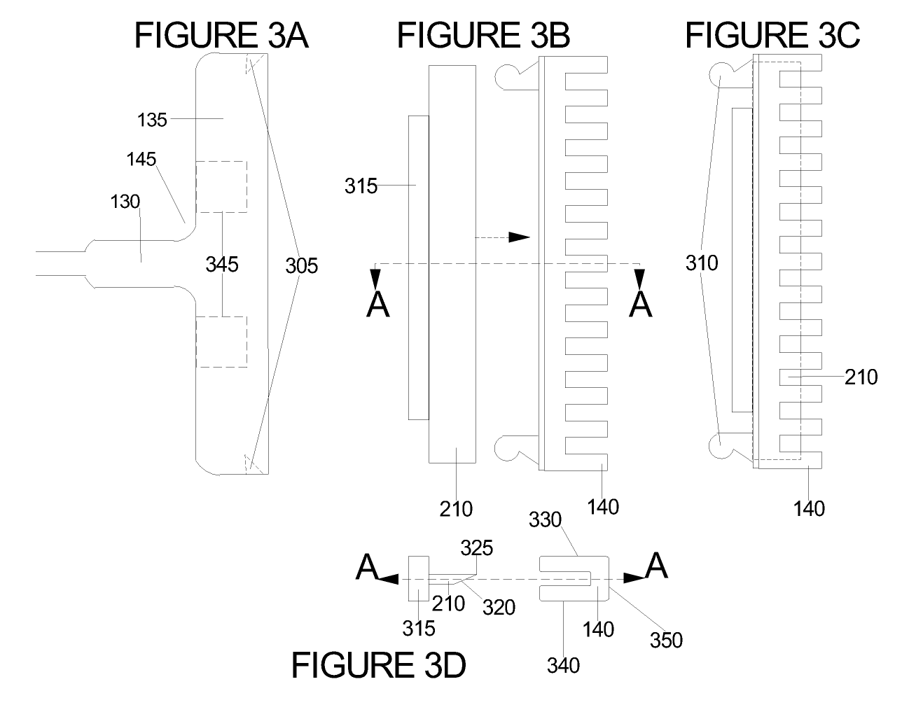

Referring now to FIG. 3A, a top plan view of a blade housing 135 and neck 130 of an exemplary hinged cutting tool, with the cutting blade 210 and comb 140 removed is provided. The blade housing 135 includes an interior compartment with connection means, such as tabs 305, to receive and releasably engage corresponding locking means, such as flexible tabs 310 (FIGS. 3B and 3C), on the comb assembly 140 and hold the cutting blade 210 in place between the blade housing 135 and comb assembly 140. However, the invention is not limited to use of tabs 305, 310. Other suitable connection and locking means, such as, for example, screws, adhesives, magnets and the like, may be utilized within the scope of the invention.

Now referring to FIG. 3B, an exploded top view of a cutting blade 210 and comb assembly 140 of an exemplary hinged cutting tool according to principles of the invention is shown. The comb assembly 140 includes locking means, such as flexible tabs 310 (FIGS. 3B and 3C), to releasably engage corresponding connection means, such as tabs 305, in the interior of the comb assembly 140. When the locking means, such as flexible tabs 310 (FIGS. 3B and 3C), of the comb assembly 140 engages corresponding connection means, such as tabs 305, in the interior of the comb assembly 140, the cutting blade 210 is held in place between the blade housing 135 and comb assembly 140. As shown in the cross section view of FIG. 3D, the exemplary comb assembly 140 features a U-shaped profile, with top 330 and bottom 340 layers joined by a tip portion 350. However, the invention is not limited to such a configuration of a comb assembly. Instead a single layer comb assembly and other comb assemblies with a plurality of teeth extending over (or under) and beyond the blade tip also come within the spirit and scope of the invention.

In addition to guiding elongated foliage into the cutting blade 210, the comb assembly provides a protective barrier. The tip portions 350 of the comb teeth prevent items larger than the space between the teeth, d (FIG. 2A), from contacting the blade 210. The space d is preferably larger than a screen aperture, but smaller than an average finger. By way of example, but not limitation, a space d of approximately 1/16 (i.e., 0.0625) to ⅓ (i.e., 0.3333) inches may be utilized within the spirit and scope of the invention. The comb teeth may extend beyond the tip of the cutting blade 210 by a determined length l (FIG. 2B) that is sufficient to prevent unintended contact with the blade. The length also helps ensure that an excessive amount of twigs or needles does not accumulate between a space. As the cutting head 145 moves forward, excess twigs and needles are encouraged to a side adjacent unfilled space, thereby distributing twigs and needles along the blade. The length l is preferably larger than a screen aperture, but not considerably larger than the space between the teeth d. By way of illustration and not limitation, a length l of approximately ⅛ (i.e., 0.125) to ½ (i.e., 0.50) inches may be utilized within the spirit and scope of the invention.

A base 315 is secured to the back side of the cutting blade 210. The base 315 provides a structure for handling the blade 210 as well as for supporting the blade 210 in an installed position. The blade 210 is installed by sliding it into the comb assembly 140. As the base 315 is sized larger than the opening of the comb assembly 140, it provides a stopping point for the installed blade 210. When the blade 210 is installed in the blade housing 135, the base 315 abuts the stoppers 345, preventing the blade from backing out of the comb assembly 140.

Turning to FIG. 3C, a top plan view of a blade assembly comprised of an assembled cutting blade 210 and comb assembly 140 of an exemplary hinged cutting tool according to principles of the invention is shown. The base 315, which is sized larger than the opening of the comb assembly 140, provides a stopping point for the installed blade 210.

FIG. 3D provides a side exploded cross-sectional view of a cutting blade 210 and comb assembly 140 of an exemplary hinged cutting tool according to principles of the invention. The blade 210 is configured to fit within the channel defined between the top 330 and bottom 340 layers of the comb assembly. The exemplary blade includes a straight sharp tip 325 and a beveled edge 320. However, the invention is not limited to a blade with that particular configuration. Other configurations, such as double-beveled edges, and angled or arcuate cutting edges may be utilized. The tip 350 of the comb assembly 140 extends outwardly beyond the tip 325 of the blade.

Thus, the cutting blade 210 may be removable. Therefore, if the cutting blade 210 becomes dull, it may be sharpened or replaced. If the cutting blade 210 is damaged, it may be replaced.

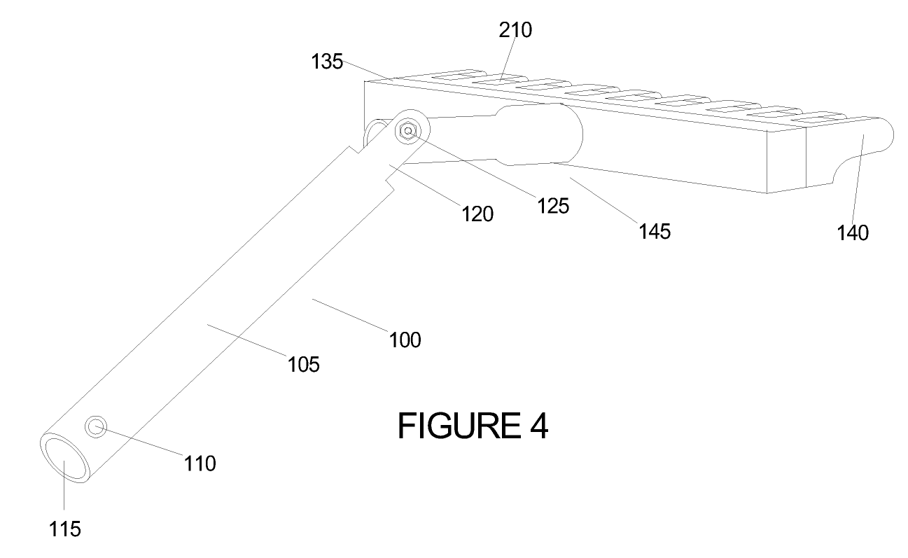

FIG. 4 provides a top perspective view of an exemplary hinged cutting tool according to principles of the invention. As discussed above, the cutting head 145 of the exemplary hinged cutting tool 100 according to principles of the invention includes a neck 130 that is hingedly joined to a handle 105 at one end and adjoined to a blade housing 135 at the opposite end. The blade housing 135 includes a removable comb assembly 140 and a cutting blade 210. The comb assembly 140 directs elongated foliage into the cutting blade 210, which severs the foliage.

The handle 105, which is generally comprised of a tubular shaft, is hingedly connected to the neck 130 of the blade housing 135. The proximal end of the handle 105 includes the fork 120 for hinged engagement of the neck 130 of the blade housing 135. The pivot pin 125 passes through the fork 120 and the neck 130 of the blade housing 135 to enable pivotal movement of the blade housing 135 relative to the handle 105. The distal end 115 of the handle 105 is adapted to receive the proximal end of an extension pole. In the exemplary embodiment, the distal end includes a pair of opposed apertures 110 for receiving button snap attachments on the corresponding proximal end of a pole.

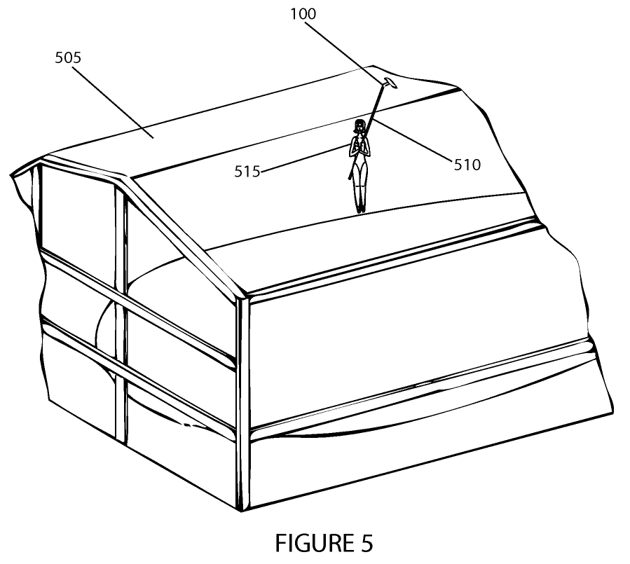

FIG. 5 is a perspective view of a woman 515 using an exemplary hinged cutting tool 100 according to principles of the invention. The cutting tool 100 is attached to the end of an extension pole 510, so that the woman may extend the cutting tool 100 to reach the interior side of the screen roof 505. If the device is equipped with a biasing means as described above, the flat top surface of the cutting head will remain in contact with the screen during use. As the cutting head is moved along the surface of the screen, protruding foliage within the path of movement is directed by the comb into the cutting blade. The cutting blade severs the foliage.

In an exemplary embodiment, the handle 105 and components of cutting head 145 of the hinged cutting tool 100 may be comprised of plastics known in the art, such as plastics based on polyethylene, polypropylene, polystyrene, polyvinylchloride, acrylics, cellulosics, acrylonitrile-butadiene-styrene terpolymers (ABS), acetal resins, polyamides, polycarbonates and polyesters. Though other materials may be used, preferably the material is corrosion resistant, light weight, durable, relatively inexpensive and capable of producing an aesthetically pleasing part. The material may further include additives to provide desired properties such as desired colors, surface textures, structural characteristics, glow-in-the dark properties. The components of the cutting head 145 of the hinged cutting tool 100 may be produced using plastic manufacturing techniques known in the art, such as injection, compression, structural foam, blow, or transfer molding; polyurethane foam processing techniques; milling and casting. Alternatively, the handle may be comprised of aluminum or other metals.

The blade 210 may be comprised of any material suitable for a sharpened cutting tool. By way of example and not limitation, steel, high carbon steel, stainless steel, or steel alloys may be utilized. The base 315 may be joined to the blade 210 using any joining means and processes capable of producing a strong, durable, waterproof, aesthetically pleasing joint. In an exemplary embodiment, a methacrylate adhesive or a methyl ethyl ketone (MEK) solvent may be used to achieve a chemical bond with little or no surface preparation. Other glues, adhesives chemical bonding agents, tapes, mechanical fasteners and the like may also be used as joining means without departing from the scope of an exemplary embodiment of the invention.

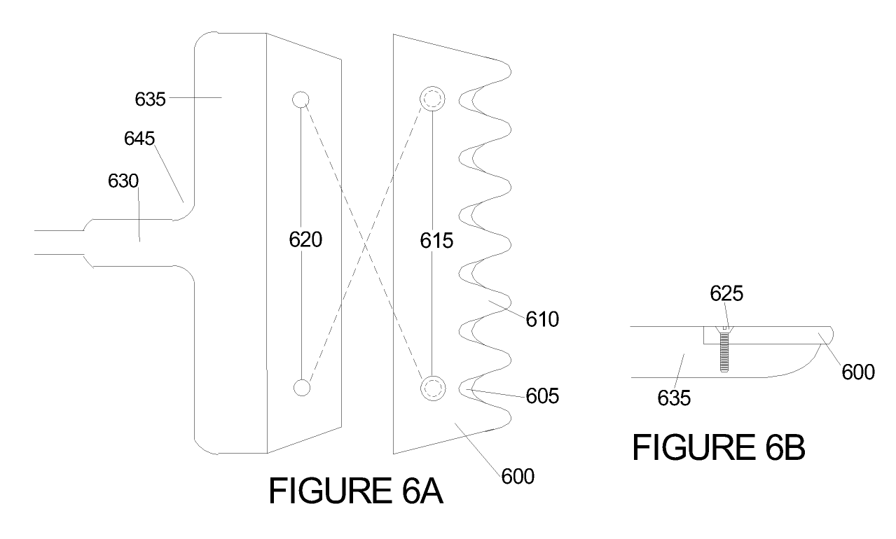

Referring now to FIG. 6A, an exploded view of another exemplary cutting head, including a top view of blade housing and a bottom view of an integral combed cutting blade of an exemplary hinged cutting tool according to principles of the invention; is provided. The cutting head 645 includes a neck 630 that may be hingedly joined to a handle at one end and adjoined to the blade housing 635 at the opposite end. The blade housing 635 includes a removable integral combed blade assembly 600. The integral combed blade assembly 600 features a plurality of cutting surfaces 605 separated by comb teeth 610. The invention is not limited to u-shaped cutting surfaces 605 as shown in FIG. 6. Other cutting surface configurations, such as v-shaped, may be utilized and come within the spirit and scope of the invention. The integral combed blade assembly 600 may be permanently attached to the blade housing 645 or releasably attached using mechanical attachments such as flat-head screws 625 adjoining the integral combed blade assembly 600 to the blade housing 645 via apertures 615, 620, of which aperture 620 may be threaded to engage the flat head screws 625. The comb teeth 610 of the integral combed blade assembly 600 directs elongated foliage into the cutting surfaces 605, which sever foliage.

Referring now to FIG. 6B, a profile view of an assembled exemplary cutting head, including a blade housing 635 and an attached integral combed cutting blade 600 of an exemplary hinged cutting tool according to principles of the invention. The cutting surfaces 605, which sever foliage, are substantially level with the top surface of the blade housing 635. This configuration enables cutting of foliage at or near the interior surface of a screen enclosure.

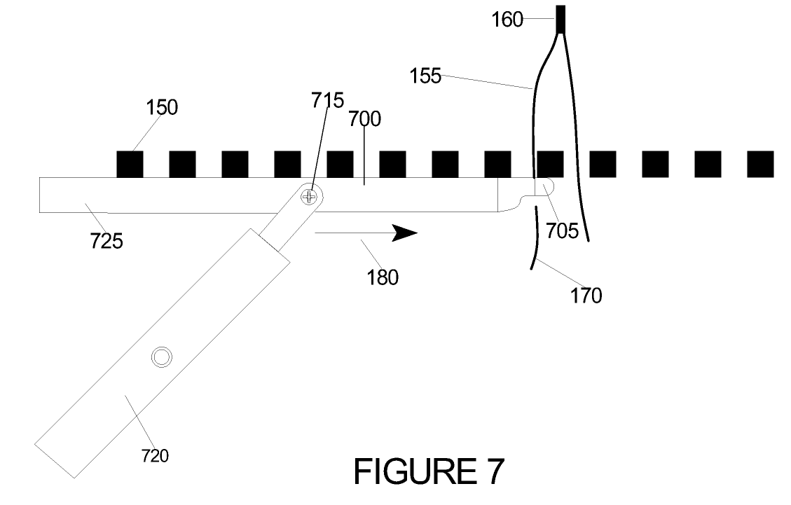

Referring now to FIG. 7, a profile view of an assembled exemplary cutting head, including an extended blade housing 700 and an attached integral combed cutting blade of an exemplary hinged cutting tool according to principles of the invention is shown. The extended cutting head 700 obviates the need for a biasing means to urge the cutting head against a surface. When the leading 710 and trailing 725 edges of the extended cutting head 700 are urged against a surface, such as a screen, the extended cutting head 700 pivots on the pivot pin 715 to an orientation substantially parallel to the surface. As the cutting head 700 is moved parallel to and along the interior surface of a screen, the comb assembly 705 directs protruding debris (e.g., needles and stems) into cutting blades, which sever the debris.

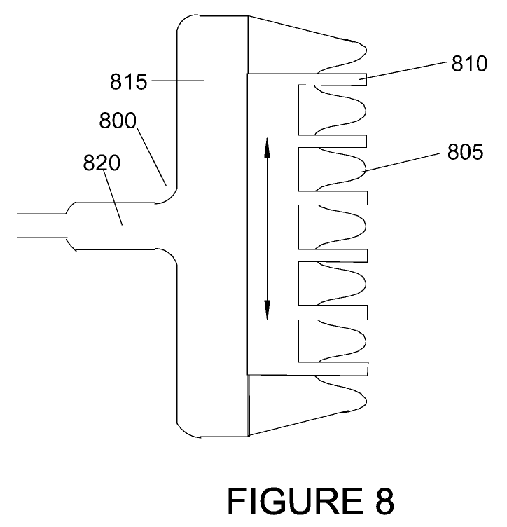

The embodiment shown in FIG. 8 includes a motor powered head assembly 800. The exemplary assembly includes a pair of elongated parallel cutting members 805, 810 which cooperate to cut engaged items, such as needles and stems. A stationary blade 805 is attached to the blade housing 815. A linearly reciprocating blade member 810 is adapted for side-to-side sliding movement along the longitudinal axis parallel relative to the fixed blade 805. The reciprocating blade member 810 is operatively coupled to a motor and reciprocating transmission (not shown) positioned within the housing 815 and adapted for driving reciprocating blade member 810 in side-to-side sliding movement in a manner known to those skilled in the art. The motor (no shown) may be an electrically powered motor or an internal combustion engine. In the case of an electrically powered motor electrical power may be supplied via rechargeable batteries, disposable batteries or an A/C cord. Rechargeable electric storage batteries (not shown) may be enclosed in the housing 815, neck 820 or another location. Motor control elements such as trigger switch and safety switch may be operably coupled to the motor and provided adjacent to the free end of a handle.

The reciprocating blade member 810 includes a plurality of prongs each having a tip end and a root end. The range of motion of the prongs of the reciprocating blade member 810 is such that the prongs completely traverse the corresponding slots of the fixed blade 805, and then returns, during a complete reciprocating cycle.

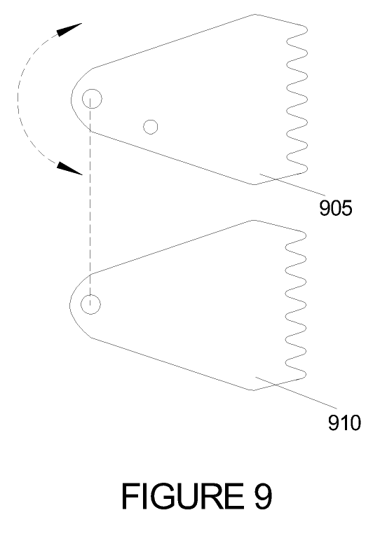

An alternative motor powered head assembly may comprise a pivotally movable blade assembly as conceptually illustrated in FIG. 9. A pivotally reciprocating blade member 905 is adapted for side-to-side pivotal movement relative to a stationary blade member 910.

While an exemplary embodiment of the invention has been described, it should be apparent that modifications and variations thereto are possible, all of which fall within the true spirit and scope of the invention. With respect to the above description then, it is to be realized that the optimum relationships for the components of the invention and steps of the process, including variations in form, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A hinged foliage cutter adapted for use against a surface of a screen enclosure, said hinged foliage cutter comprising:
a cutting head having a proximal end, a distal end, a top side and a bottom side, the top side of the cutting head being substantially flat;
a handle having a distal end and a proximal end, said proximal end of the handle being hingedly attached to the distal end of the cutting head;
a cutting blade attached to the proximal end of the cutting head, said cutting blade having a top side, a bottom side and a tip; and
a comb assembly attached to the proximal end of the cutting head, said comb assembly including a plurality of comb teeth, said comb teeth abutting at least one of the top side and bottom side of the cutting blade and extending beyond the tip of the cutting blade by a determined length.

2. A hinged foliage cutter according to claim 1 wherein the distal end of the handle includes means for releasable attachment to an extension pole.

3. A hinged foliage cutter according to claim 2 wherein the distal end of the handle is comprised of a tubular shaft.

4. A hinged foliage cutter according to claim 3 wherein the means for releasable attachment to an extension pole is comprised of an attachment means from the group consisting of:
at least one spring biased button snap attachment;
at least one aperture for receiving at least one spring biased button snap attachment;
female threads;
male threads; and
a tapered interior compartment of the tubular shaft comprising the handle.

5. A hinged foliage cutter according to claim 1 wherein the distal end of the cutting head includes a neck having a distal end and a proximal end, the distal end of the neck being adapted for hinged attachment the proximal end of the handle.

6. A hinged foliage cutter according to claim 5 wherein the proximal end of the handle includes a forked end adapted for hinged attachment to the distal end of the neck of the cutting head.

7. A hinged foliage cutter according to claim 6 wherein the distal end of the neck of the cutting head includes a forked end adapted for hinged attachment to the proximal end of the handle.

8. A hinged foliage cutter according to claim 1, wherein the proximal end of the cutting head includes a blade housing adapted for releasably receiving the cutting blade and comb assembly.

9. A hinged foliage cutter according to claim 1, wherein the comb assembly includes means for releasable attachment to the cutting head.

10. A hinged foliage cutter according to claim 9, wherein:
the comb assembly includes a top comb layer, a bottom comb layer and a comb tip adjoining the top comb layer to the bottom comb layer, said comb assembly having a unshaped profile; and
the cutting blade includes a blade with a sharp tip at one end and a base at the opposite end, said cutting blade being inserted into the comb assembly up to the base.

11. A hinged foliage cutter according to claim 1, wherein the comb assembly includes a plurality of comb teeth separated by a determined distance.

12. A hinged foliage cutter according to claim 1, wherein said determined distance is 1/16 to ⅓ inches.

13. A hinged foliage cutter according to claim 1, wherein the comb assembly includes a plurality of comb teeth that extend beyond the tip of the cutting blade by a determined length.

14. A hinged foliage cutter according to claim 1, wherein the determined length is ⅛ to ½ inches.

15. A hinged foliage cutter according to claim 1, further comprising a biasing mechanism adapted to urge the cutting head to a determined angular position relative to the handle.

16. A hinged foliage cutter according to claim 15, wherein the biasing mechanism comprises a torsion spring.

17. A hinged foliage cutter according to claim 15, wherein the determined angular position relative to the handle is zero degrees.

18. A hinged foliage cutter according to claim 15, wherein the biasing mechanism urges the cutting head to a determined angular position by producing a torque sufficient to overcome gravitational force acting on the cutting head, but not so great as to damage a screen.

19. A hinged foliage cutter adapted for use against a surface of a screen enclosure, said hinged foliage cutter comprising:
a cutting head having a proximal end, a distal end, a top side and a bottom side, the top side of the cutting head being substantially flat;
a handle having a distal end and a proximal end, said proximal end of the handle being hingedly attached to the distal end of the cutting head;
a reciprocating cutting blade assembly attached to the proximal end of the cutting head, said reciprocating cutting blade assembly comprising a first bade member having a plurality of cutting prongs and being movable relative to a second blade member having another plurality of cutting prongs in a reciprocating cutting motion; and
a motor operably coupled to a transmission, said motor and transmission being adapted to controllably move the first blade member relative to the second blade member in a reciprocating cutting pattern.

20. A hinged foliage cutter adapted for use against a surface of a screen enclosure, said hinged foliage cutter comprising:
a cutting head having a proximal end, a distal end, a top side and a bottom side, the top side of the cutting head being substantially flat;
a handle having a distal end and a proximal end, said proximal end of the handle being hingedly attached to the cutting head intermediate the distal end and proximal end of the cutting head;
a cutting blade attached to the proximal end of the cutting head, said cutting blade having a top side, a bottom side and a tip; and
a comb assembly attached to the proximal end of the cutting head, said comb assembly including a plurality of comb teeth, said comb teeth abutting at least one of the top side and bottom side of the cutting blade and extending beyond the tip of the cutting blade by a determined length.
